(19) United States
(12) Patent Application Publication
(10) Pub. No.: US 2019/0064913 A1
(43) Pub. Date: Feb. 28, 2019

(54) SYSTEM AND METHOD FOR COLLABORATIVE COMPUTING POWER

(71) Applicant: Walmart Apollo, LLC, Bentonville, AR (US)

(72) Inventors: John J. O'Brien, Farmington, AR (US); Donald R. High, Noel, MO (US); Brian McHale, Oldham (GB); Todd Mattingly, Bentonville, AR (US); Robert Cantrell, Herndon, VA (US); Trey Bishop, Bentonville, AR (US); Nick Antel, Bentonville, AR (US)

(73) Assignee: Walmart Apollo, LLC, Bentonville, AR (US)

(21) Appl. No.: 16/116,599

(22) Filed: Aug. 29, 2018

Related U.S. Application Data
(60) Provisional application No. 62/551,435, filed on Aug. 29, 2017.

(51) Int. Cl. G06F 1/32; G06F 9/50; G06F 1/28; H04L 9/06

(52) U.S. Cl. CPC G06F 1/329; H04L 9/0637; G06F 1/28; G06F 9/5094

(57) ABSTRACT

Systems, methods, and computer-readable storage media for distributing computing resources among two or more devices. As a device determines that it needs additional computing resources, it sends a request to other devices requesting that those other devices take on a portion of the computing which needs to occur. As devices receive the request, responses to the request are generated and sent back to the requesting device, each response providing an answer as to the ability of each respective device to fulfill the request. The requesting device receives the responses, aggregates and/or analyzes the responses, and determines how to transition information and resources to a new computing configuration based on the responses. These changes would be broadcast to the group through the mesh network, with any computing resource transitions likewise similarly being broadcast to the group.

### BACKGROUND

### 1. Technical Field

The present disclosure relates to collaborative computing power, and more specifically to distributing computing power among two or more wireless devices.

### 2. Introduction

As the Internet of Things continues to evolve, communications between devices continues to evolve. For example, autonomous cars are being designed to use mesh networks for communications between cars, such that every car is aware of the speed, direction, braking, etc., of the other cars. Drones and Unmanned Aerial Vehicles are being similarly designed, allowing unprecedented coordination. Similarly, devices within the home, such as thermostats and light switches, can communicate with one another to save power and improve power efficiency.

However, while the currently available communications between devices or vehicles allow for more informed devices, they do not necessarily improve other aspects of the devices. For example, having more informed devices does not, by itself, provide for collaborative computing, collaboratively storing data in databases, collaboratively sharing battery power, and/or collaboratively sharing digital currency between those informed devices.

### SUMMARY

A method for performing concepts disclosed herein can include: identifying, via a processor at a first device in a plurality of devices, a need for additional computing capacity to complete a computation; transmitting, via a wireless mesh network, a request for the additional computing capacity to one or more member devices in the plurality of devices, wherein the request indicates a planned computing state required to achieve the additional computing capacity; receiving, via the wireless mesh network and from the one or more member devices in the plurality of devices, a plurality of responses to the request, wherein each response in the plurality of responses contains a binary competence of a respective member device in the plurality of devices to provide the additional computing capacity; aggregating, via the processor, the plurality of responses to the request until a predefined time period expires, to yield aggregated responses, wherein the aggregated responses comprise a state of computing power being used by each device in the plurality of devices when the request was made; modifying the planned computing state based on the aggregated responses, to yield a modified planned computing state, wherein in the modified planned computing state the need for additional computing capacity is distributed between the processor and at least one additional member device in the plurality of member devices; initiating the modified planned computing state within the first device; performing, via the processor and in the modified planned computing state, at least a portion of the computation; and transmitting instructions to the at least one additional member device to execute the modified planned computing state to complete at least a remainder portion of the computation.

A system configured as disclosed herein can include: a processor; and a computer-readable storage medium having instructions stored which, when executed by the processor, cause the processor to perform operations comprising: identifying, at a first device in a plurality of devices, a need for additional computing capacity; transmitting a request for the additional computing capacity to one or more member devices in the plurality of devices, wherein the request indicates a planned computing state required to achieve the additional computing capacity; receiving, from at least one member device in the plurality of devices, at least one response to the request, wherein the at least one response contains a binary competence of the at least one member device to provide the additional computing capacity; and initiating, based on the binary competence, the planned computing state based on the at least one response to the request.

A non-transitory computer-readable storage medium configured as disclosed herein can have instructions stored which, when executed by a computing device, cause the computing device to perform operations which include: identifying, at a first device in a plurality of devices, a need for additional computing capacity; transmitting a request for the additional computing capacity to one or more member devices in the plurality of devices, wherein the request indicates a planned computing state required to achieve the additional computing capacity; receiving, from at least one member device in the plurality of devices, at least one response to the request, wherein the at least one response contains a binary competence of the at least one member device to provide the additional computing capacity; and initiating, based on the binary competence, the planned computing state based on the at least one response to the request.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates exemplary connections between devices in the Internet of Things;

FIG. 2 illustrates an exemplary mesh network between unmanned vehicles/devices;

FIG. 3 illustrates an exemplary blockchain based on interactions between devices;

FIG. 4 illustrates an exemplary method of transitioning resources between devices;

FIG. 5 illustrates an example of binary competence;

FIG. 6 illustrates an exemplary method embodiment; and

FIG. 7 illustrates an exemplary computer system.

### DETAILED DESCRIPTION

Systems, methods, and computer-readable storage media configured according to this disclosure are capable of distributing computing resources among two or more devices. As a device determines that it needs additional computing resources, it sends a request to other devices requesting that those other devices take on a portion of the computing which needs to occur. This distribution request can, for example, be broadcast through a mesh network between devices, until all the devices within a group, or within a radius of the initial requesting device, have received the request. As devices receive the request, responses to the request are generated and sent back to the requesting device, each response providing an answer as to the ability of each respective device to fulfill the request. The requesting device receives the responses, aggregates and/or analyzes the responses, and determines how to transition information and resources to a new computing configuration based on the responses. In some cases, this can require transferring information from the requesting device to another device through the mesh network. In addition, this can require modifying computing capacities or configurations at the requesting device as well as other devices within the group of devices. These changes would be broadcast to the group through the mesh network, with any computing resource transitions likewise similarly being broadcast to the group.

Consider the following example. A smart home is configured with a smart thermostat, smart refrigerator, smart washing machine, smart dryer, smart microwave, and a smart oven. Each of these devices are capable of being remotely controlled and configured by a user through a WiFi connection each device has with a WiFi network. In addition, the smart devices within this smart home can communicate with one another, such that the smart thermostat can communicate with the smart microwave, the smart refrigerator can communicate with the smart washing machine, etc. In some configurations, such communications can utilize a mesh network (i.e., each device communicates with the other devices directly using RF, low power, Bluetooth, or other wireless short range communication mechanisms, or if direct communication is not possible due to power or range restriction, indirectly through communication relays provided by another device in the group), whereas in other configurations the communications occur directly though the Wifi network.

As a device in the smart home begins a computation associated with an assigned task, the device can determine if distributing the computation, or portions of the computation, to other devices in the smart home is likely to be desirable. For example, would such distribution improve the speed of the computation, the efficiency of the computation, overextend the device performing the computation, etc., and would such improvements likely outweigh the costs of sending a request to other devices, receiving responses, and making adjustments based on those responses?

This determination as to whether sending a request would likely be desirable can be based on historical data. More specifically, the device making the request can determine if similar requests in the past proved to result in increased efficiency, or if they resulted in wasted resources. In addition, the device making the request can identify a range where, based on responses, it may make the request despite a statistical calculation indicating that the likely result will be wasted resources.

In some configurations, communications between the devices can take the form of a blockchain, where each request and response made by devices can be added to the blockchain ledger. As any device takes an action (sending a request, sending a response to a request), that information is added to the blockchain. More specifically, the request, response, or other action is hashed into the previous blockchain. This new, updated blockchain is then distributed to the other devices within the group.

In some configurations, requests for resources, and responses to the request, can take the form of a binary competency. For example, whereas a normal request for help may result in a binary response from a responding device, where providing a “1” indicates the responding device is able to meet the request and a “0” indicates the responding device is unable to meet the request, with a binary competency response an array of values indicates just how capable the responding device is to fulfill the request. In one example, if a first device requests that the second device allocate 50 k processor flops to a computation, the second device could provide a response indicating it is not fully able to meet that demand, but can assist to a degree. An exemplary response may take the form of “0000001000”, a ten-digit binary response, where each binary digit represents a percentage of competence for the second device to fulfill the request. In this example, the “1” is found at the seventh digit, indicating that the second device is 70% capable of providing the 50 k flops requested, or that the second device can provide 35 k flops, but not 50 k flops.

The example of an array of binary digits indicating competence to fulfill a request, with each binary digit expressing the responding device's ability to fulfill the request within 10% windows, can vary according to needs and precision desired. For example, the binary competence can have a longer length/shorter corresponding windows. If more than one factor is being requested (i.e., resources in a specified time window), the binary competence can have multiple arrays indicating competence based on availability. Alternatively, the binary competence can be one extended array, with different portions of the array providing distinct details about the responding device's capabilities and availability.

The example of a smart home is provided above. However, in other circumstances the devices may be unmanned or autonomous vehicles, drones, robotics, communication devices, or any other electronic device. For example, in one configuration the devices communicating availability may be delivery drones, whereas in another configuration the devices may be autonomous vehicles or smart home devices. In yet another configuration, the devices may be distinct types of devices, such as a drone and smart home devices communicating, making requests, and generating responses to those requests.

Distributing computing resources, or collaborative sharing of computing power, among the devices can include sharing processor and/or memory utilization. By implementing the requests/responses, the devices within a group can determine which devices are unused, under utilized, or in use, and will allow the entire group of devices to share the computing power workload. In other words, devices in the group can collaborate using distributed intelligence as it relates to their respective computing power and can make decisions on sharing the computing power workload. To do this, each device has a predictive element as part of its operations, whereby each of the devices understands its own peaks and troughs of performance, and can be ready to share their computing capacity based on that understanding. This can help with registry and shared repository information of devices within the network, failing devices, backup and recovery of information, etc. For example, the group of devices may share a registry redundantly among themselves or on the cloud which would also provide a method of failover from one device to another, or from the cloud. In other words, just because a smart toaster burns up does not mean the data about bread consumption is lost.

The information shared on between devices (i.e., on the mesh network) will do so in a peer-peer network of devices that is decentralized. That is, all devices have the potential for sharing and distributing information on the computing power needed. This system can be authenticated, shared, and managed, by a block chain system for authentication and decentralization. For instance, if a first device receives a request from an individual, such as order groceries, yet the workload for that first device is at full capacity, the first device can relay an initial block chain of information, as a request, to all other devices in the group. This request can contain the grocery list, time stamp, digital currency information, authentication information, etc. Other devices within the group will receive and authenticate the transmission, then provide computing power to solve the request from the first device. This in turn causes an update to the previous block within the block chain, which will contain the “slave” (second) device's updates with the original “master” initial block (the request). Thus, information will be accurately shared between the devices with the necessary information, including updates, etc.

By sharing the data and information between devices, replacement devices can be swapped and retain the history from the prior devices once the devices make the association. An association can be made either by manufacture's data from a web site using an API call, or by a user making the association. For example, a broken coffee maker version 1 may be replaced by version 2 and the version 2 machine would gather the version 1 data from the network once it is registered into the network. All the data associated with version 1 would now carry over to the version 2. Data could be when different coffees were used, how many cups, and when predicted inventories of coffee need to be replenished. What would not carry over would be the old version 1 maintenance schedule, if there was one. If the coffee maker was swapped out for a different type of coffee maker, the user may have to do the association through the new coffee machine to let it know it needs to retain the old coffee maker data. This may not be automatic because in some instances a location may want to use more than one coffee maker and still keep the old information. In such circumstances it would not be a replacement, but rather an addition.

The information shared and transmitted between devices (such as requests for assistance, responding to requests for assistance, authentication, and protocol sharing), can utilize block chain or other authentication methods. Exemplary data which can be stored on a device (and transmitted/received between devices as required) can include a history log, a usage of the device, consumption of power (or other measurement of use), maintenance performed, downtime, consumption of products or other received elements, and/or schedule for future usage.

To share tasks and actions can require moving data, updating or changing processors, modifying memory, or other similar tasks. In one example, a device is scheduled to perform a task but determines it would be faster if another device could share in the task. One way the device can do this is by planning a shared task configuration, where the task is divided between the device and another device in a planned manner, sending the shared task configuration to other devices to determine availability. If another device can assist, the initiating device could send out a signal to the other device to alter its configuration (i.e., processor or memory) to perform the task as instructed by the initiating device. Simultaneously, the initiating device can modify its configuration according to the planned shared task configuration.

Another way the device can share the task is to send a request to other devices inquiring about the availability of the other devices. Upon receiving the responses to the request, the initiating device can aggregate and analyze the responses, then determine based on the aggregated/analyzed data how to divide the task. This determination would result in a planned shared task configuration, which could be sent to the other devices in the group. The initiating device and the other devices could then modify their respective configurations to match the planned shared task configuration and perform the task.

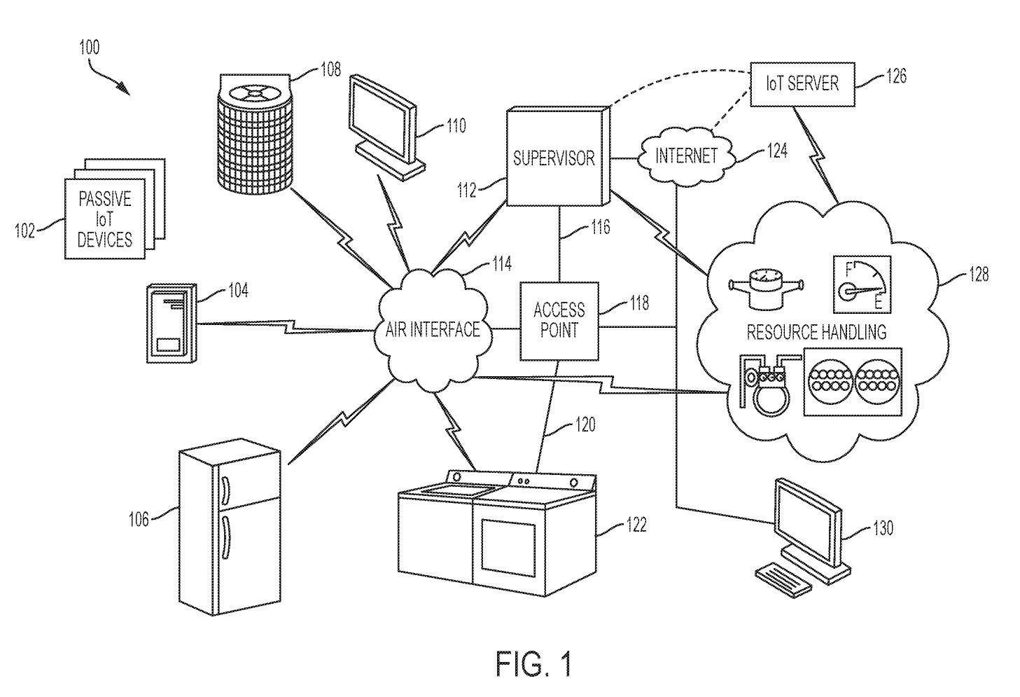

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. The disclosure now turns to FIG. 1.

FIG. 1 illustrates exemplary connections 100 between devices in the Internet of Things (IoT), or smart devices. These devices can be passive IoT devices 102, or can be active devices. These devices, also known as “smart” devices, are capable of communicating via networks (such as the Internet 124) with one another and/or users. Exemplary devices illustrated can include thermostats 104, refrigerators 106, washer/dryer units 122, air conditioning units 108, and television monitors 110. These devices are, preferably, connected via a wireless network or air interface 114 via an access point 118. In some configurations, the access point 118 can have wired connections 120, 116 to the devices 102.

A supervisor 112 can be, for example, an application (“app”) on a smartphone which organizes the information associated with the IoT devices 102, or a human being operating the app. This supervisor 112 can help with resource handling 128, where the specific resources for each device are organized and scheduled. This resource handling 128 can, for example, be performed on an IoT server 126. Communications with the access point 118 can further include mechanisms via the Internet 124 and/or other computers 130.

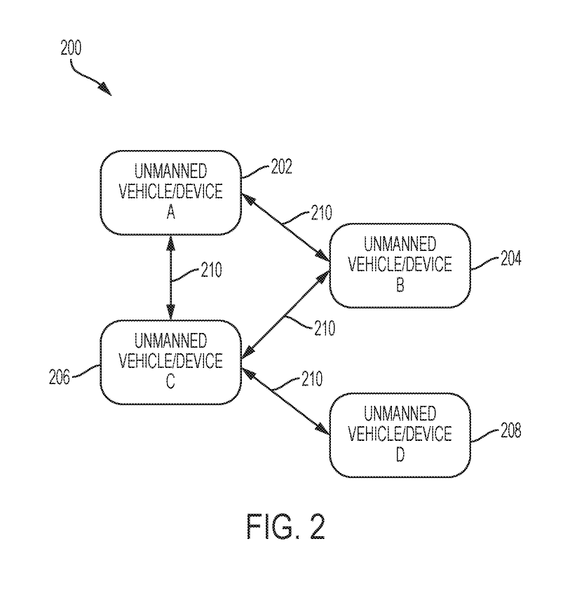

FIG. 2 illustrates an exemplary mesh network 200 between unmanned vehicles/devices 202, 204, 206, 208. A mesh network such as that illustrated is a network where each node can relay data from and to other nodes within the network. While mesh networks can be constructed to operate in wired conditions, they are more prevalent in wireless configurations, where messages can be broadcast/flooded to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node A 202 can communicate 210 with nodes B 204 and C 206, and nodes B 204 and C 206 can communicate 210 with each other. However, nodes A 202 and B 204 cannot communicate with node D 208. Because node D 208 can only communicate with node C 206, any communications 210 between node A 202 and node D 208, or between node B 204 and node D 208, must route through node C 206.

When requesting and distributing computing resources, the various exemplary devices illustrated in FIG. 1 and discussed above may communicate with one another via a mesh network 200. That is, the devices can transmit, receive, and relay messages between themselves as necessary.

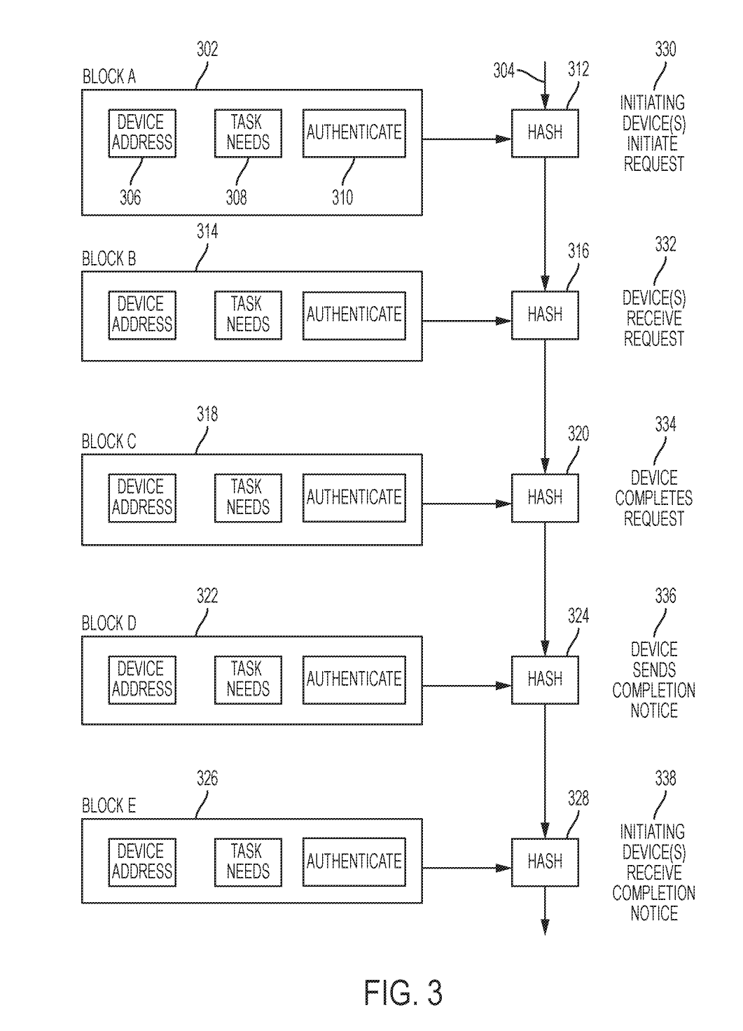

FIG. 3 illustrates an exemplary blockchain based on interactions between devices. A blockchain is a distributed digital ledger which is communicated electronically between devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of distributing computational requests, and reallocating computational tasks among the various devices based on the responses to the requests, the blockchain can take the form illustrated in FIG. 3. In this example, there is a blockchain 304 which has been distributed among multiple devices. One of the devices, an initiating device, determines that distributing a computation among other devices would be a better outcome, and proceeds to initiate a request 330. Initiation of the request, in this example, includes generating a block (Block A 302). In this example, each block added to the block chain contains the device address 306 or identification of the device making the request, responding to the request, or otherwise communicating with the remaining devices in the group of devices. The blocks can contain the task needs 308, which can include the specific request for resources or actions, responses to requests, completion notifications, etc. In addition, the blocks can contain an authentication 310 portion, where the device can approve or authenticate the validity of other transactions and/or provide authority for the present transaction.

As the device generates the block 302 for the initial request, the block 302 is hashed 312 into the previous blockchain 304, resulting in an updated blockchain which is distributed among the devices in the group. The other devices receive the updated blockchain containing the request 332 and generate blocks 314 in response to the request. These responses are hashed 316 into the blockchain. In some scenarios, an additional block could be generated by the initiating device based on the response blocks 314, indicating what action will be taken based on the responses received.

When a device completes the request 334, that device generates a block 318 which is subsequently hashed 320 and added to the blockchain. If a completion notice 336 needs to be generated and sent to the initiating device, the completing device can generate another block 322, which can similarly be hashed 324 and added to the blockchain. Once the initiating device receives the completion notice 338, it may generate a notification indicating the request has been fulfilled, which would similarly require a block 326 to be generated and hashed 328 into the blockchain.

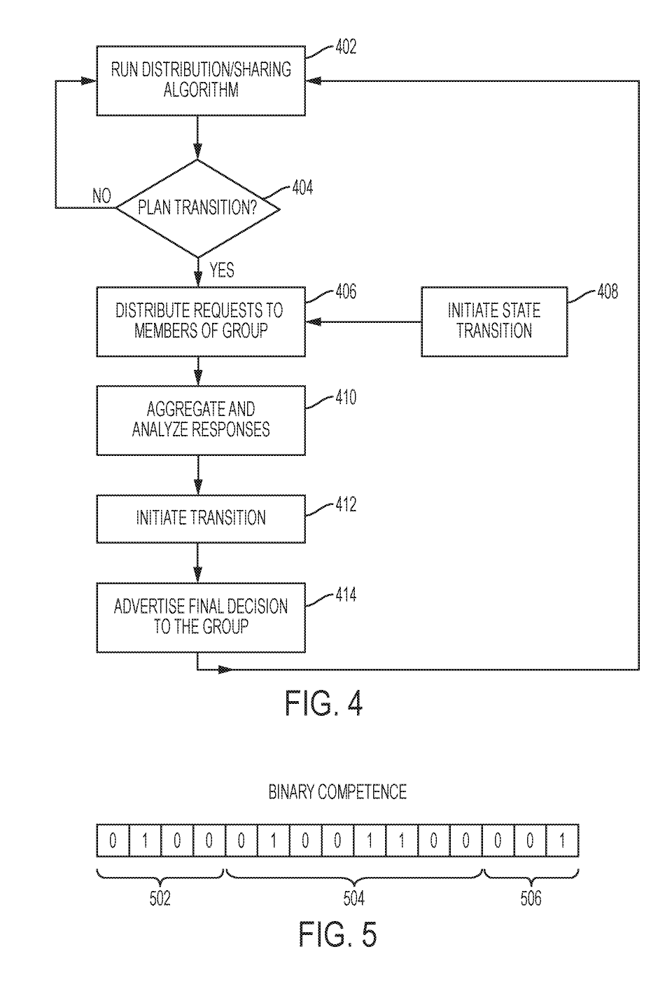

FIG. 4 illustrates an exemplary method of transitioning resources between devices. This exemplary method can be performed, for example, by any device within a group of devices, and can be used to distribute resources, share resources, transition actions, or otherwise between devices in a group. A device in the group of devices can run a distribution/sharing algorithm 402, where the algorithm analyzes what tasks the device is scheduled to perform, how much time those tasks will take, how much power/capacity/ability the device has, and determines if something needs to change to better perform the assigned tasks. In other words, does a transition 404 need to occur? This transition can be internal to the device and/or involve other devices in the group of devices.

If the transition needs to occur, and the transition will involve other members of the group of devices, requests for assistance can be distributed to other devices within the group 406. In addition, the device (or another device) can initiate a state transition 408, where the configuration of the network of devices can be will be modified. For example, if a task needs to be shared among multiple devices, the processor, memory, or other aspects of the computing systems can be modified to transition to a new configuration, or state, to accommodate that shared task. In some cases, the requesting device can identify what this state would look like and communicate that state to other devices within the request, whereas in other instances the state transition 408 can be initiated after receiving responses 410 from devices within the group.

In response to the requests distributed to the group 406, responses are received from the group of devices, which the initial device aggregates and analyzes 410. Based on these responses, the initiating device can initiate a transition 412 to a new configuration which will allow the task in question to be performed. The initiating device advertises the final decision to the group 414, the task is completed in the new configuration (i.e., with data distributed, computing or other tasks shared, and/or using updated processes). At this point the process can return to the initial diagnostic algorithm 402 for the device.

FIG. 5 illustrates an example of binary competence. In this example, the binary competence takes the form of an array of binary digits, with distinct portions 502, 504, 506 corresponding to specific aspects of a request. If, for example, this were a binary competence request, the first portion 502 could correspond to availability to perform the task in the next two minutes, the second portion 504 could correspond to competence in performing specific aspects of the task, and the third portion 506 could correspond to competence in power required to shift resources to perform the task. In other configurations, the types, sizes, and dimensions of binary competence can vary as needed by specific configurations. For example, in some configurations, each binary value in an array could represent a specific percentage of competence to perform a task. In other configurations, such as that illustrated, the binary competence can be divided into distinct portions associated with distinct capabilities. In addition, in some configurations, the binary competence can be in more than one dimension, such as a table (2D), a cube (3D), or expressed in 4+ dimensions.

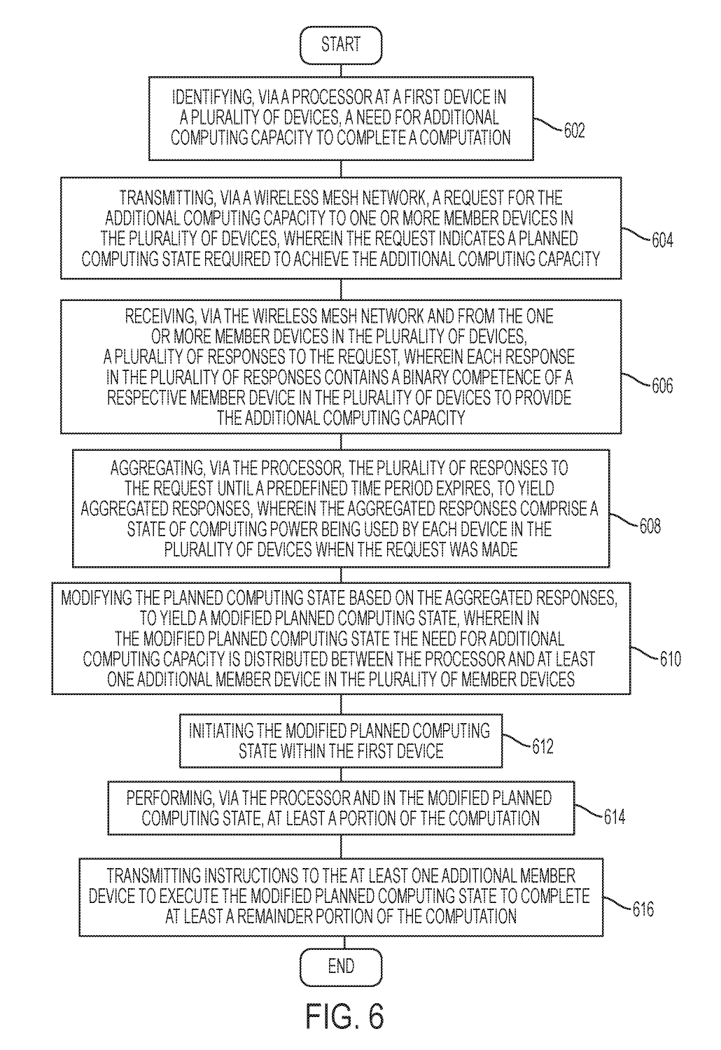

FIG. 6 illustrates an exemplary method embodiment which can be performed by a computing device, such a smart device, server, or any other computing device configured to perform according to the concepts disclosed herein. In this example, the device identifies, via a processor at a first device in a plurality of devices, a need for additional computing capacity to complete a computation (602). The device transmits, via a wireless mesh network, a request for the additional computing capacity to one or more member devices in the plurality of devices, wherein the request indicates a planned computing state required to achieve the additional computing capacity (604). The device then receives, via the wireless mesh network and from the one or more member devices in the plurality of devices, a plurality of responses to the request, wherein each response in the plurality of responses contains a binary competence of a respective member device in the plurality of devices to provide the additional computing capacity (606).

The device aggregates, via the processor, the plurality of responses to the request until a predefined time period expires, to yield aggregated responses, wherein the aggregated responses comprise a state of computing power being used by each device in the plurality of devices when the request was made (608), and modifies the planned computing state based on the aggregated responses, to yield a modified planned computing state, wherein in the modified planned computing state the need for additional computing capacity is distributed between the processor and at least one additional member device in the plurality of member devices (610). The device initiates the modified planned computing state within the first device (612) and performs, via the processor and in the modified planned computing state, at least a portion of the computation (614). The device also transmits instructions to the at least one additional member device to execute the modified planned computing state to complete at least a remainder portion of the computation (616). In some configurations, this method can be augmented to include planning a state transition to the modified planned computing state based on a local computing power algorithm at the first device. Likewise, in some configurations, the method can include sharing a final decision indicating that the modified planned computing state will be initiated to the plurality of devices by updating a block chain ledger shared among the plurality of devices and initiating the modified planned computing state subsequent to sharing the final decision.

Moreover, the exemplary method can, for example, require that at least one response in the plurality of responses is incorporated into a block chain. Similarly, in some configurations, the binary competence can indicate a degree to which each member device in the plurality of devices may be able to assist with the request. Furthermore, initiating the modified planned computing state can comprise reallocating computing resources within at least one of the processor and a memory electronically connected to the processor.

In some configurations, each device in the plurality of devices can analyze a potential impact associated with the planned computing state based on a dependency tree that describes relationships among the plurality of devices, and determine whether the each device may assist with the planned computing state based on a potential impact to the each device. In such configurations, it may be that when a member device in the plurality of devices has no computing power resources available the member device does not send a response to the request. Similarly, at least one member device in the plurality of devices can be designated as a proxy device to determine whether to approve or disapprove the planned computing state on behalf of the at least one member device.

It is noted that components, elements, features, and/or limitations of this method can be combined as needed for specific configurations. For example, another exemplary method using this disclosure may be: identifying, at a first device in a plurality of devices, a need for additional computing capacity; transmitting a request for the additional computing capacity to one or more member devices in the plurality of devices, wherein the request indicates a planned computing state required to achieve the additional computing capacity; receiving, from at least one member device in the plurality of devices, at least one response to the request, wherein the at least one response contains a binary competence of the at least one member device to provide the additional computing capacity; and initiating, based on the binary competence, the planned computing state based on the at least one response to the request.

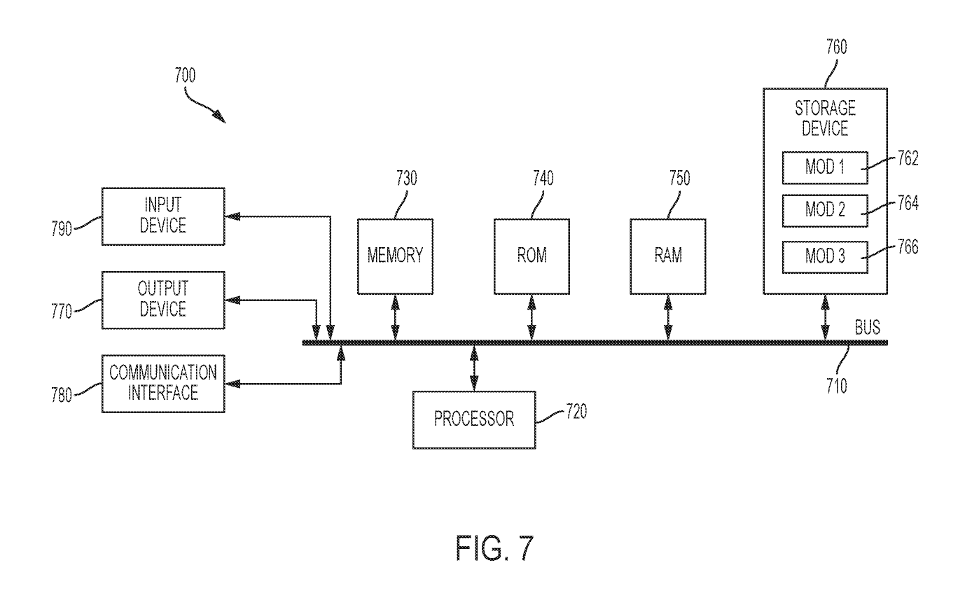

With reference to FIG. 7, an exemplary system 700 can include a processing unit (CPU or processor) 720 and a system bus 710 that couples various system components including the system memory 730 such as read only memory (ROM) 740 and random access memory (RAM) 750 to the processor 720. The system 700 can include a cache of high speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
identifying, via a processor at a first device in a plurality of devices, a need for additional computing capacity to complete a computation;
transmitting, via a wireless mesh network, a request for the additional computing capacity to one or more member devices in the plurality of devices, wherein the request indicates a planned computing state required to achieve the additional computing capacity;
receiving, via the wireless mesh network and from the one or more member devices in the plurality of devices, a plurality of responses to the request, wherein each response in the plurality of responses contains a binary competence of a respective member device in the plurality of devices to provide the additional computing capacity;
aggregating, via the processor, the plurality of responses to the request until a predefined time period expires, to yield aggregated responses, wherein the aggregated responses comprise a state of computing power being used by each device in the plurality of devices when the request was made;
modifying the planned computing state based on the aggregated responses, to yield a modified planned computing state, wherein in the modified planned computing state the need for additional computing capacity is distributed between the processor and at least one additional member device in the plurality of member devices;
initiating the modified planned computing state within the first device;
performing, via the processor and in the modified planned computing state, at least a portion of the computation; and
transmitting instructions to the at least one additional member device to execute the modified planned computing state to complete at least a remainder portion of the computation.

2. The method of claim 1, further comprising:
planning a state transition to the modified planned computing state based on a local computing power algorithm at the first device.

3. The method of claim 1, wherein at least one response in the plurality of responses is incorporated into a block chain.

4. The method of claim 1, wherein the binary competence indicates a degree to which each member device in the plurality of devices may be able to assist with the request.

5. The method of claim 1, wherein each device in the plurality of devices analyzes a potential impact associated with the planned computing state based on a dependency tree that describes relationships among the plurality of devices and determines whether the each device may assist with the planned computing state based on a potential impact to the each device.

6. The method of claim 5, wherein when a member device in the plurality of devices has no computing power resources available the member device does not send a response to the request.

7. The method of claim 5, wherein at least one member device in the plurality of devices designates a proxy device to determine whether to approve or disapprove the planned computing state on behalf of the at least one member device.

8. The method of claim 1, further comprising:
sharing a final decision indicating that the modified planned computing state will be initiated to the plurality of devices by updating a block chain ledger shared among the plurality of devices; and
initiating the modified planned computing state subsequent to sharing the final decision.

9. The method of claim 1, wherein initiating the modified planned computing state comprises reallocating computing resources within at least one of the processor and a memory electronically connected to the processor.

10. A system, comprising:
a processor; and
a computer-readable storage medium having instructions stored which, when executed by the processor, cause the processor to perform operations comprising:
identifying, at a first device in a plurality of devices, a need for additional computing capacity;
transmitting a request for the additional computing capacity to one or more member devices in the plurality of devices, wherein the request indicates a planned computing state required to achieve the additional computing capacity;
receiving, from at least one member device in the plurality of devices, at least one response to the request, wherein the at least one response contains a binary competence of the at least one member device to provide the additional computing capacity; and
initiating, based on the binary competence, the planned computing state based on the at least one response to the request.

11. The system of claim 10, the computer-readable storage medium having additional instruction stored which, when executed by the processor, cause the processor to perform operations comprising:
aggregating a plurality of responses to the request, including the at least one response, until a predefined time period expires, to yield aggregated responses, wherein the aggregated responses comprises a state of computing power being used when the request was made by each device in the plurality of devices; and
upon concluding the predefined time period, analyzing the aggregated responses to determine whether to initiate the planned computing state.

12. The system of claim 10, the computer-readable storage medium having additional instruction stored which, when executed by the processor, cause the processor to perform operations comprising:
planning a state transition to the planned computing state based on a local computing power algorithm at the first device.

13. The system of claim 10, wherein the at least one response to the request is incorporated into a block chain.

14. The system of claim 10, wherein the binary competence indicates a degree to which the at least one member device may be able to assist with the request.

15. The system of claim 10, wherein each device in the plurality of devices analyzes a potential impact associated with the planned computing state based on a dependency tree that describes relationships among the plurality of devices and determines whether the each device may assist with the planned computing state based on a potential impact to the each device.

16. The system of claim 15, wherein when a member device in the plurality of devices has no computing power resources available the member device does not send a response to the request.

17. The system of in claim 10, wherein the at least one member device in the plurality of devices designates a proxy device to determine whether to approve or disapprove the planned computing state on behalf of the at least one member device.

18. The system of claim 10, the computer-readable storage medium having additional instruction stored which, when executed by the processor, cause the processor to perform operations comprising:
sharing a final decision indicating that the planned computing state will be initiated to the plurality of devices by updating a block chain ledger shared among the plurality of devices; and
initiating the planned computing state subsequent to sharing the final decision.

19. A non-transitory computer-readable storage medium having instructions stored which, when executed by a computing device, cause the computing device to perform operations comprising:
identifying, at a first device in a plurality of devices, a need for additional computing capacity;
transmitting a request for the additional computing capacity to one or more member devices in the plurality of devices, wherein the request indicates a planned computing state required to achieve the additional computing capacity;
receiving, from at least one member device in the plurality of devices, at least one response to the request, wherein the at least one response contains a binary competence of the at least one member device to provide the additional computing capacity; and
initiating, based on the binary competence, the planned computing state based on the at least one response to the request.
